(19) United States
(12) Patent Application Publication
(10) Pub. No.: US 2025/0358316 A1
(43) Pub. Date: Nov. 20, 2025

(54) NETWORK MAPPING BEHAVIOR ANOMALY DETECTION METHOD AND SYSTEM BASED ON MACHINE LEARNING

(71) Applicant: Huaneng Information Technology Co., Ltd., Qingdao (CN)

(72) Inventors: Ziqiang Wen, Qingdao (CN); Shuo Han, Qingdao (CN); Sheng Ye, Qingdao (CN); Hao Guo, Qingdao (CN); Qifeng Wu, Qingdao (CN); Lei Chen, Qingdao (CN); Faxing Chen, Qingdao (CN); Fuhai Gao, Qingdao (CN); Yan Li, Qingdao (CN); Yuxiang Lu, Qingdao (CN)

(73) Assignee: Huaneng Information Technology Co., Ltd., Qingdao (CN)

(21) Appl. No.: 19/281,509

(22) Filed: Jul. 25, 2025

(30) Foreign Application Priority Data
Jul. 11, 2025 (CN) CN202510961733.X

(51) Int. Cl. H04L 9/40

(52) U.S. Cl. CPC H04L 63/1491; H04L 63/1425

(57) ABSTRACT

A network mapping behavior anomaly detection method and system based on machine learning is provided. The method includes: collecting dual-source traffic data, generating a structured log data set through dual-source log fusion engine; performing subgraph matching calculation to obtain a mapping behavior deviation degree; generating communication data containing a watermark identifier in a session corresponding communication path; verifying whether attack events carry the watermark identifier; generating a network mapping behavior anomaly detection report. According to the disclosure, an adaptive attack behavior model is constructed through a multi-modal feature vector based on structured logs and a graph protocol mapping rule base, so that the cognitive robustness to protocol camouflage and path drift is fundamentally enhanced, a real-time verification chain of detection results is built, and traditional passive detection is transformed into self-proof active defense through cross verification of watermark carrying state and behavior trajectory.

### CROSS-REFERENCE TO RELATED APPLICATIONS

This application claims priority of Chinese Patent Application No. 202510961733.X, filed on Jul. 11, 2025, the content of which is hereby incorporated by reference.

### TECHNICAL FIELD

The disclosure relates to the technical field of network mapping behavior anomaly detection, and in particular to a network mapping behavior anomaly detection method and system based on machine learning.

### BACKGROUND

The cross-integration of cyberspace mapping technology and network security anomaly detection has become the key direction of the evolution of active defense system. In the field of network mapping, the asset topology modeling technology based on graph structure breaks through the limitations of traditional IP list, and realizes the dynamic characterization of infrastructure through multi-dimensional probe strategy. The automatic mapping framework has supported the coverage detection of cloudy environment. At the same time, anomaly detection technology has gradually changed from threshold judgment to behavior pattern cognition. The behavior feature vector extraction mechanism defined by ITU may integrate the protocol interaction state transition features and the service access spatial distribution features, providing a quantitative basis for complex attack chain identification.

However, there are still limitations in the prior art, for example, the attack chain rules mostly rely on the static rule base, and it is impossible to perceive the path drift in multi-step attacks. This leads to the problems of high false alarm, low adaptability and incomplete situation coverage in the existing network defense system.

### SUMMARY

The purpose of the disclosure is to provide a network mapping behavior anomaly detection method and system based on machine learning, which are used to realize intelligent detection and traceability of network mapping behavior and transform traditional passive detection into self-proof active defense.

In order to achieve the above objectives, the disclosure provides a network mapping behavior anomaly detection method based on machine learning, including: collecting dual-source traffic data based on honeypot nodes, generating a structured log data set through dual-source log fusion engine; constructing an anomaly detection model and attack chain fragments based on the structured log data set, and generating attack behavior deduction rules according to the attack chain fragments; performing subgraph matching calculation based on the structured log data set and the attack behavior deduction rules to obtain a mapping behavior deviation degree; generating communication data containing a watermark identifier in a session corresponding communication path based on the mapping behavior deviation degree; verifying whether attack events carry the watermark identifier, and updating the anomaly detection model according to verification results; and generating a network mapping behavior anomaly detection report according to output of an updated anomaly detection model and the mapping behavior deviation degree.

Optionally, constructing an anomaly detection model and attack chain fragments based on the structured log data set, and generating attack behavior deduction rules according to the attack chain fragments include: extracting attack context labels from the structured log data set; combining protocol interaction temporal features and service access distribution features according to the attack context labels, so as to construct a model analysis feature vector; based on the model analysis feature vector, learning a sequence transfer pattern of the attack context labels by using long short-term memory networks, and identifying statistical outliers of protocol interaction parameters by using an isolated forest algorithm to construct the anomaly detection model; extracting frequent itemsets from an attack context sequence in the structured log data set by using a frequent pattern growth algorithm, and generating the attack chain fragments according to the frequent itemsets; and converting the attack chain fragments into executable behavior deduction rules by using a protocol feature mapping method.

Optionally, performing subgraph matching calculation based on the structured log data set and the attack behavior deduction rules to obtain a mapping behavior deviation degree includes: converting the attack chain fragments in the attack behavior deduction rules into an attack chain graph; extracting protocol interaction event streams of a current session from the structured log data set, constructing a behavior trajectory graph, and marking temporal relationships between events; searching a subgraph matched with the attack chain graph in the behavior trajectory graph by adopting a graph structure matching algorithm, and calculating structural similarity between a matched subgraph and the attack chain graph; and performing time constraint verification on the matched subgraph, and calculating the mapping behavior deviation degree based on the structural similarity and time constraint verification results.

Optionally, generating communication data containing a watermark identifier in a session corresponding communication path based on the mapping behavior deviation degree includes: when the mapping behavior deviation degree exceeds a set deviation degree threshold, determining whether there is a potential attack risk in a session; when there is the potential attack risk in the session, selecting a corresponding watermark injection strategy according to a current communication protocol to generate the communication data containing the watermark identifier; and performing a protocol specification compliance check on the communication data containing the watermark identifier.

Optionally, verifying whether attack events carry the watermark identifier includes: continuously monitoring whether the watermark identifier is carried in an attack event subsequent request, and recording a carry state of the watermark identifier; and performing behavior path verification by comparing a behavior trajectory of the watermark identifier carried by the attack events with an expected path in the attack behavior deduction rules.

Optionally, updating the anomaly detection model according to verification results includes: if an attack event behavior trajectory matches attack chain rules and completely carries the watermark identifier, marking a data record of an attack as an attack chain matching normal sample; and if the attack event behavior trajectory deviates from a path, or the watermark identifier is tampered with or deleted, marking a data record of an attack as an attack chain matching anomaly sample, and triggering the anomaly detection model to adjust.

Optionally, updating the anomaly detection model according to verification results further includes: for the attack chain matching normal sample, increasing a confidence score of a corresponding rule in the attack chain rules; for the attack chain matching anomaly sample, based on a tampered pattern of the watermark identifier, constructing an adversarial sample, adding the adversarial sample to a training set of the anomaly detection model, and adjusting parameter weights of the anomaly detection model.

Optionally, generating a network mapping behavior anomaly detection report according to output of an updated anomaly detection model and the mapping behavior deviation degree includes: combining the output of the updated anomaly detection model and the mapping behavior deviation degree, and determining a risk level of the network mapping behavior abnormality according to results of the behavior path verification; marking an anomaly behavior type, and extracting an identifier of the attack chain segment and the mapping behavior deviation degree matching with a current behavior; marking affected infrastructure resources based on the structured log data set; and recording time windows when anomaly behaviors occur.

Optionally, generating a network mapping behavior anomaly detection report according to output of an updated anomaly detection model and the mapping behavior deviation degree further includes: constructing and outputting a three-dimensional situation graph, where the three-dimensional situation graph includes an asset graph, a behavior graph and a threat graph; and integrating a report field, where the report field includes a determination result of the risk level, the anomaly behavior type, the identifier of the attack chain fragments, the mapping behavior deviation degree, the affected infrastructure resources and the time windows, and obtaining the network mapping behavior anomaly detection report.

On the other hand, the disclosure provides a network mapping behavior anomaly detection system based on machine learning, which is used for realizing a network mapping behavior anomaly detection method based on machine learning. The system includes a control module, where the control module includes a memory, a processor and a computer program stored in the memory and executable on the processor, and the processor executes the computer program to realize the network mapping behavior anomaly detection method based on machine learning.

In the above technical scheme, an adaptive attack behavior model is constructed by using a multimodal feature vector based on structured logs and a graph protocol mapping rule base, so that the cognitive robustness to protocol camouflage and path drift is fundamentally enhanced. Secondly, the innovative communication watermark identification tracking system builds a real-time verification chain of detection results, and through the cross-verification of watermark carrying state and behavior trajectory, the traditional passive detection is transformed into self-proof active defense. Graph structure deviation algorithm and three-dimensional situation engine deeply integrate asset topology, threat behavior and multi-source elements of time window, and realize the essential characterization of complex attacks such as lateral movement under the premise of low false alarm. The self-evolution closed loop of rule confidence iteration, adversarial sample feedback and model parameter adjustment is formed, which drives the system to continuously refine new attack patterns in the adversarial environment and systematically solves the shortcomings of verification delay, situation fragmentation and static rule base rigidity in traditional network mapping behavior anomaly detection.

Other features and advantages of the disclosure will be described in detail in the following detailed embodiments.

### BRIEF DESCRIPTION OF THE DRAWINGS

The accompanying drawings are provided to provide a further understanding of the disclosure and constitute a part of the description, and together with the following detailed embodiments, serve to explain the disclosure, but may not constitute a limitation of the disclosure. In the attached drawings:

FIG. 1 is a flowchart of network mapping behavior anomaly detection based on machine learning; and

FIG. 2 is a flow chart for calculating the mapping behavior deviation degree.

### DETAILED DESCRIPTION OF THE EMBODIMENTS

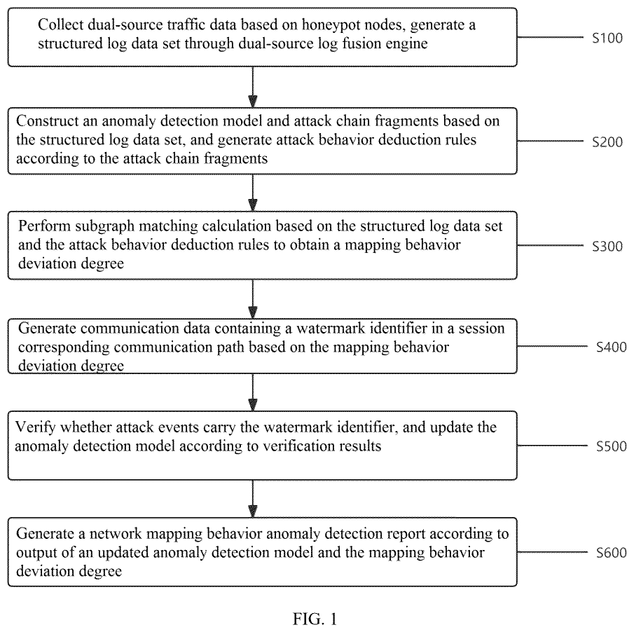

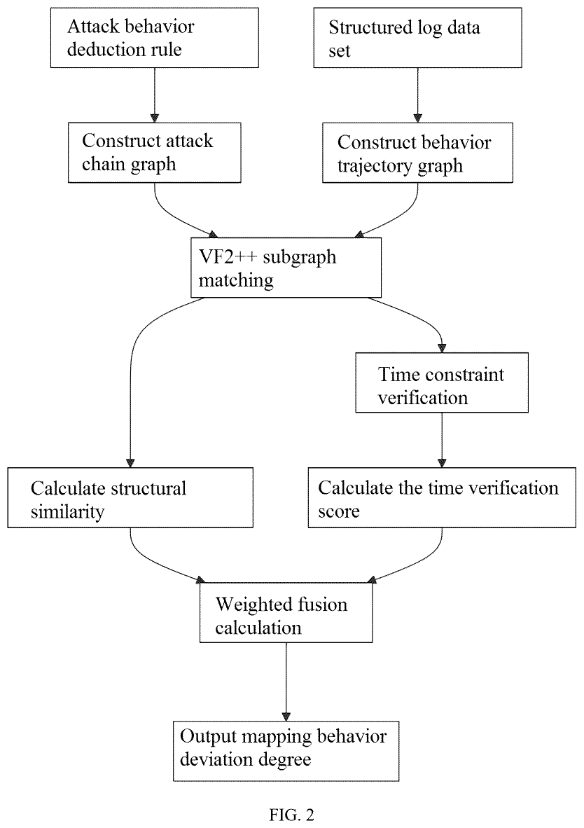

In the following, the specific implementation of the embodiment of the disclosure will be described in detail with reference to FIGS. 1-2. It should be understood that the specific embodiments described here are only used to illustrate and explain the embodiments of the disclosure, and are not used to limit the embodiments of the disclosure.

It should be noted that the acquisition, transmission, storage, use and processing of data in the technical scheme of the disclosure comply with the relevant provisions of national laws and regulations. In the embodiment of the disclosure, some existing solutions of software, assemblies, models and other industries may be mentioned, which should be considered as exemplary, and the purpose is only to illustrate the feasibility in the implementation of the technical solution of the disclosure, but it may not mean that the applicant has already or necessarily used this solution.

In the process of realizing the disclosure, the inventors of the disclosure find that there are some defects in the prior art, such as verification delay, situation fragmentation and static rule base rigidity in the traditional network mapping behavior anomaly detection.

### Embodiment 1

Referring to FIG. 1-FIG. 2, a first embodiment of the disclosure is provided, and provides a network mapping behavior anomaly detection method based on machine learning, including:

S100: dual-source traffic data is collected based on honeypot nodes, a structured log data set is generated through dual-source log fusion engine.

Specifically, a highly interactive honeypot cluster is deployed in the core area of the network, which is designed with a modular architecture and includes dozens of common service types (such as Web server, database service, industrial control protocol simulation, etc.). Port mirroring technology is used to capture two kinds of core data in real time: firstly, the full-flow mirror data packet of the production environment is obtained, and the transport layer load is stripped by using Deep Packet Inspection (DPI) technology. At the same time, the metadata of attack behavior generated during the interaction of honeypot system is recorded, including attack vector, vulnerability exploitation load and session state machine information. The dual-source log fusion engine integrates the two types of data sources based on the timestamp alignment mechanism, analyzes the original log content through the predefined regular expression rule base, and analyzes the original traffic by using the diamond model analysis framework. The five-tuple basic features (source Internet protocol address, source transmission control protocol port, transport layer protocol type, target Internet protocol address, target transmission control protocol port) are extracted, traffic type label (normal business request/network mapping behavior/attack exploitation behavior) is labeled, and session-level behavior sequence features (port access frequency, protocol interaction order, request load entropy value) are aggregated, so as to obtain a labeled structured log data set.

Preferably, attack behavior metadata (attack vectors, vulnerability exploitation loads) is captured by deploying highly interactive honeypot clusters, and the full-traffic image of the production environment is obtained based on port mirroring technology, and a labeled structured log data set is generated by using dual-source log fusion engine (based on timestamp alignment mechanism and regular expression rule base), which provides standardized input for subsequent anomaly detection.

S200: an anomaly detection model and attack chain fragments are constructed based on the structured log data set, and attack behavior deduction rule are generated according to the attack chain fragments.

Further, attack context labels are extracted from the structured log data set; protocol interaction temporal features and service access distribution features are combined according to the attack context labels, so as to construct a model analysis feature vector; based on the model analysis feature vector, a sequence transfer pattern of the attack context labels are learned by using long short-term memory (LSTM) networks, and statistical outliers of protocol interaction parameters are identified by using an isolated forest algorithm to construct the anomaly detection model; the frequent itemsets are extracted from an attack context sequence in the structured log data set by using a frequent pattern growth algorithm, and the attack chain fragments are generated according to the frequent itemsets; and the attack chain fragments are converted into executable behavior deduction rules by using a protocol feature mapping method.

Specifically, firstly, the attack context labels are extracted from the structured log data set, and the initial label set is constructed by analyzing the labeled traffic type labels, such as attack utilization behavior and corresponding five-tuple features, and session-level behavior sequence features, such as port access frequency and request load entropy value, combined with metadata such as attack vector and vulnerability utilization load. Then, according to the attack context labels, after dimensionality reduction, the protocol interaction temporal features (such as Markov transition probability matrix of protocol interaction sequence) and service access distribution features (such as target port access frequency histogram) are fused. A high-dimensional feature vector is constructed; where, the time series features are segmented for statistics and are performed normalization processing by sliding window, and the distribution features are encoded by entropy-weighted multidimensional histogram. Then, the two-way LSTM network is used to train the time series sequence of attack context labels, and the dependency relationship between attack phases is captured by the gating unit to learn the probability model of attack phase transition. At the same time, the isolated forest algorithm is used to detect the single-dimensional and multi-dimensional outliers of protocol parameters, such as the variance of load length distribution. The Local Outlier Factor (LOF) score is combined to quantify the degree of anomaly, finally, the sequence transition probability output by LSTM is weighted and fused with the outlier score of isolated forest to obtain a mixed anomaly detection model. Then, based on the frequent pattern growth algorithm, the frequent itemsets in the attack context sequence are mined, the minimum support degree threshold is set to screen the high-frequency attack chain pattern, and the attack chain fragments are generated through the association rule confidence degree evaluation. Finally, the attack chain fragments are transformed into an executable rule by using the protocol feature mapping method. Each attack stage in frequent itemsets is mapped to the feature template of the corresponding protocol layer, a state machine model is constructed through conditional logic expressions, and MITRE ATT and the TTPs number (Tactics, Techniques, and Procedures, Tactics, technology and procedure number) of CK framework (the Mitre Corporation Adversary Tactics, Techniques, and Common Knowledge, the framework of adversarial tactics, technology and common sense in the Federal Aviation System Technology Center of Massachusetts Institute of Technology, USA) are combined to perform semantic labeling to form interpretable behavior deduction rules.

Preferably, the historical mapping data is pre-trained by deploying a semantic feature extractor of the two-way encoder representation architecture, and the deep semantic features of protocol interaction are mined by attention mechanism. On the other hand, a feature enhancement module based on adversarial generation network is constructed to generate detection behavior samples simulating advanced persistent threat organizations, so as to expand the coverage area of feature base. At the same time, key feature sets are screened by a feature importance evaluation algorithm (such as SHAP value calculation and shapley additive interpretation value calculation), and an interpretable detection rule set is generated. In the accurate identification stage of mapping subjects, firstly, a multi-modal feature fusion unit is built to integrate network layer features, including five-tuple, transport layer security protocol (TLS fingerprint), application layer features (service identification information, application programming interface call sequence) and time features (access period, scanning rhythm). Then, the graph neural network module is deployed to analyze the correlation relationship between mapping subjects based on the knowledge map of multidimensional association containing IP (Internet Protocol)-Domain Name-Vulnerability-CVE (Common Vulnerability and Exposures). Finally, the intention inference engine is realized. By integrating the diamond model analysis engine and the anti-mapping alarm fusion device, the malicious degree score of the mapping subject is generated, and the malicious degree score of the mapping subject is integrated into the subsequent network mapping behavior anomaly detection report.

Preferably, a hybrid anomaly detection model is constructed by integrating LSTM time series modeling and an isolated forest statistical outlier detection method, which significantly improves the detection accuracy and interpretability. At the same time, high-frequency attack paths are mined, attack chain fragments are generated, and the executable behavior deduction rules are formed.

S300: subgraph matching calculation is performed based on the structured log data set and the attack behavior deduction rules to obtain a mapping behavior deviation degree.

Further, the attack chain fragments in the attack behavior deduction rules are converted into an attack chain graph; protocol interaction event streams of a current session are extracted from the structured log data set, a behavior trajectory graph is constructed, and the temporal relationships between events are marked; a subgraph matched with the attack chain graph in the behavior trajectory graph is searched by adopting a graph structure matching algorithm, and structural similarity between a matched subgraph and the attack chain graph is calculated; and time constraint verification is performed on the matched subgraph, and the mapping behavior deviation degree is calculated based on the structural similarity and time constraint verification results.

Specifically, firstly, the attack chain fragments in the attack behavior deduction rules are converted into attack chain graphs. Based on MITRE ATT, CK tactical hierarchy relationship and protocol interaction dependency relationship, a directed acyclic graph is constructed, in which nodes represent attack stages, such as vulnerability utilization payload delivery and lateral movement detection, and edges represent temporal dependency or resource correlation relationship. Label node attributes include protocol features, load features and time constraints. Then, the protocol interaction event streams of the current session are extracted from the structured log data set, and the session is reorganized according to five-tuple. The time window sliding method is used to capture the protocol interaction sequence, and a behavior trajectory graph is constructed, in which nodes represent protocol interaction events (including metadata such as transport layer security protocol version and transmission control protocol window size), while edges represent the event temporal relationship, and event intervals are marked by timestamp difference values. The subgraph matching strategy based on VF2++ algorithm is used, the subgraph matching with the topological structure of attack chain graph is searched in the behavior trajectory graph, and the graph editing distance is introduced as the measurement index when calculating the structural similarity, so as to quantify the node attribute matching degree and edge connection consistency. The matched subgraph is performed time constraint verification, including counting the time window parameters corresponding to each stage of the attack chain graph, such as the maximum interval between vulnerability detection and permission maintenance. By comparing with the event timestamp sequence of the corresponding subgraph in the behavior trajectory graph, whether the time offset exceeds the preset threshold is calculated, and the time sequence deviation of the asynchronous event sequence is corrected by using the fast dynamic time warping algorithm. The final mapping behavior deviation degree is calculated by weighted fusion structural similarity and time verification score, and the calculation formula of the mapping behavior deviation degree is:

$$M B D = 1 - ( α \cdot {S}_{GED} + β \cdot {T}_{DWT} ) ;$$

where, MBD represents the mapping behavior deviation degree, and α, and β both represent the weight coefficient. According to the temporal sensitivity adjustment of historical attack data, S_{GED} represents the structural similarity and T_{DWT} represents the time verification score.

Preferably, the attack chain fragments in the attack behavior deduction rules are transformed into attack chain graphs, and the protocol interaction event streams of the current session are extracted from the structured log data set to construct a behavior trajectory graph, and the temporal relationships between events are labeled. The VF2++ algorithm is used to search the subgraph matching the attack chain graph in the behavior trajectory graph, the structural similarity is calculated, and whether the time offset meets the expectation is evaluated by combining the time constraint verification mechanism. Finally, the mapping behavior deviation degree is calculated by weighted fusion structural similarity and time verification score, which is used to quantify the deviation degree between the current behavior and the known attack patterns, realize the objective and dynamic evaluation of the deviation degree of the attack path, and reduce the risk of subjective misjudgment.

S400: communication data containing a watermark identifier is generated in a session corresponding communication path based on the mapping behavior deviation degree.

Further, when the mapping behavior deviation degree exceeds a set deviation degree threshold, whether there is a potential attack risk in a session is determined; when there is the potential attack risk in the session, a corresponding watermark injection strategy is selected according to a current communication protocol to generate the communication data containing the watermark identifier; and a protocol specification compliance check is performed on the communication data containing the watermark identifier.

Specifically, when the mapping behavior deviation degree exceeds the dynamic threshold (based on the historical attack data distribution setting), it is determined that there is a potential attack risk in the current session. Firstly, the protocol adapter is triggered according to the communication protocol type, and the corresponding watermark injection template is selected from the preset strategy library. For example, under the HTTP protocol (Hypertext Transfer Protocol), the server field in the response header is selected to embed a 64-bit coded watermark identifier, under TCP (Transmission Control Protocol Options), a specific byte sequence is injected into the TCP selection field of three-way handshake, and the ICMP protocol (Internet Control Message Protocol) modifies the low-order bits of the identifier field. Watermark generation adopts redundant coding algorithm, such as Hamming code check, which combines unique session ID (Identifier), timestamp hash value and attack chain fragment identifier to ensure that the watermark is within the legal scope of the protocol field.

Further, after generating the communication data containing the watermark, a protocol specification compliance check is performed. Firstly, the protocol parsing library is called to verify the value range of the field, and then the L4/L3 layer checksum, such as TCP pseudo header checksum, is regenerated by the checksum and calculation module. Finally, the protocol state machine simulator is deployed to detect the interaction continuity. If the field is found to be out of bounds or the state is abnormal, the watermark re-injection mechanism is triggered, and the bit width of the watermark is reduced by adjusting the coding parameters, and the data packet conforming to the protocol specification is regenerated. For the multi-stage attack scenario, the recursive watermark injection strategy is adopted, and the sequence number associated with the initial watermark is continuously embedded in the subsequent interactive data stream to ensure the integrity of attack path tracking.

Preferably, when the mapping behavior deviation degree exceeds the set threshold, it is determined that there is a potential attack risk in the session, and the corresponding watermark injection strategy is selected according to the current communication protocol, and a unique watermark identifier is embedded in the communication data. Then, field legality check, verification and recalculation, and state machine simulation verification are performed on the communication data with watermark, so as to ensure that the watermark still conforms to the protocol specification after injection. For multi-stage attack scenarios, recursive watermark injection strategy is used to continuously track the attack path, which enhances the attack traceability and closed-loop control mechanism.

S500: whether attack events carry the watermark identifier is verified, and the anomaly detection model is updated according to verification results.

Further, whether the watermark identifier is carried in an attack event subsequent request is continuously monitored, and a carry state of the watermark identifier is recorded; and behavior path verification is performed by comparing a behavior trajectory of the watermark identifier carried by the attack events with an expected path in the attack behavior deduction rules.

Specifically, the watermark identifier carrying status in subsequent requests of attack events is continuously monitored by deploying a watermark verification engine. Firstly, the protocol parsing module is used to extract the encoded watermark data from specific fields of data packets (such as TCP option fields), and the cyclic redundancy check is used to verify integrity. Then the session ID and timestamp hash in the watermark are decrypted by the pre-shared key to verify authenticity. Then, the behavior trajectory graph of the attack event is dynamically compared with the expected path in the attack chain rule: the continuity of watermark-carrying nodes in the behavior trajectory graph is detected by subgraph isomorphism matching algorithm, and the node coverage (such as the completion ratio of attack stage) and temporal consistency (such as the dynamic time warping distance) of the actual path and the expected path are counted to complete the behavior path verification.

Further, if the behavior trajectory of the attack event matches the attack chain rule and completely carries the watermark identifier, the data record of this attack is marked as an attack chain matching normal sample. If the behavior trajectory of the attack event deviates from the path, or the watermark identifier is tampered with or deleted, the data record of the attack is marked as an attack chain matching anomaly sample, and the adjustment of the anomaly detection model is triggered.

Further, for the attack chain matching normal sample, a confidence score of a corresponding rule in the attack chain rules is increased; and for the attack chain matching anomaly sample, based on a tampered pattern of the watermark identifier, an adversarial sample is constructed, the adversarial sample is added to a training set of the anomaly detection model, and parameter weights of the anomaly detection model are adjusted.

Preferably, for normal samples, the confidence score corresponding to the attack chain rule is updated by using the exponential weighted moving average (EWMA) algorithm, and the confidence score update formula is as follows:

$${C}_{new} = γ {C}_{old} + ( 1 - γ ) {M}_{match} ;$$

Where, C_{new} represents the updated rule confidence, γ represents the attenuation weight of historical confidence, C_{old} represents the historical confidence before updating, and M_{match} represents the current attack event path matching quality.

Further, for anomaly samples, firstly, the watermark tampering patterns are extracted by differential analysis, such as specific field bit inversion and load offset amount offset, and an adversarial sample generator is constructed to simulate a strategy of the attacker's bypassing detection, and the adversarial sample is injected into the training set of anomaly detection model in proportion (such as 20%), and an online incremental learning framework, such as FTRL optimizer, is adopted to dynamically adjust the weights of gating units of LSTM network and the calculation parameters of outliers in isolated forests. Finally, the model evaluation index is updated through the confusion matrix. When the recall rate is higher than the preset threshold, the solidified model parameters are updated and synchronized to the real-time detection module of honeypot cluster.

Preferably, a real-time five-tuple filter is deployed in the traffic access layer to intercept 90% non-threatening traffic. The computation-intensive modules such as LSTM/subgraph matching are transplanted to GPU cluster processing, and watermarking related operations are accelerated by FPGA intelligent network card hardware. Through the automatic capacity expansion and contraction mechanism of Kubernetes (often called k8s), the number of instances of Pod (Container Group) for data analysis is dynamically expanded at the peak of business, so as to achieve the optimal balance between resource efficiency and detection performance.

Preferably, by monitoring whether the watermark identifier is carried in the subsequent request of the attack event, and the carrying status are recorded. The behavior trajectory graph of the attack event is dynamically compare with the expected path in the attack chain rules to complete the behavior path verification. If the attack event path match and completely carries the watermark, the attack event path is marked as a normal sample and the corresponding rule confidence is improved. If the path deviates or the watermark is tampered with/deleted, the attack event path is marked as an anomaly sample and the model adjustment mechanism is triggered, and an adversarial sample is constructed to join the training set. The online incremental learning framework is adopted to optimize the model parameters, so as to realize the adaptive update and performance optimization of the anomaly detection model.

S600: a network mapping behavior anomaly detection report is generated according to output of an updated anomaly detection model and the mapping behavior deviation degree.

Further, the output of the updated anomaly detection model and the mapping behavior deviation degree are combined, and a risk level of the network mapping behavior abnormality is determined according to results of the behavior path verification; an anomaly behavior type is marked, and an identifier of the attack chain segment and the mapping behavior deviation degree matching with a current behavior are extracted; affected infrastructure resources are marked based on the structured log data set; and time windows are recorded when anomaly behaviors occur.

Further, the behavior path verification results include the attack chain matching degree, and the calculation formula of the attack chain matching degree is as follows:

$$attack chain matching degree = \frac{\begin{matrix}number of overlapping nodes between \\ actual trajectory and expected path\end{matrix}}{total number of nodes in expected path} \times 100 \%$$

This index is used to evaluate the matching degree between the attack behavior and the preset attack pattern. In order to further improve the accuracy, the subgraph isomorphism matching algorithm is combined to verify the logical consistency between nodes, and the node weight mechanism is introduced to distinguish the key attack stages.

Further, the following are the risk rating criteria based on the two core dimensions of mapping behavior deviation degree and attack chain matching degree, as shown in Table 1.

TABLE 1
Risk level determination standard table

| MBD\matching | | | | |
|---|---|---|---|---|
| degree | ≥90% | 70%-89% | 50%-69% | <50% |
| ≤0.3 | level 0 | level 1 | special | special |
| | (low | (medium | scene A | scene B |
| | risk) | risk) | | |
| 0.3-0.6 | level 1 | level 1 | level 2 | level 3 |
| | (medium | (medium | (high | (emergency) |
| | risk) | risk) | risk) | |
| 0.6-0.9 | special | level 2 | level 2 | level 3 |
| | scene C | (high | (high | (emergency) |
| | | risk) | risk) | |
| >0.9 | special | level 3 | level 3 | level 3 |
| | scene D | (emergency) | (emergency) | (emergency) |

Further, the special scene processing rules in Table 1 are shown in Table 2.

TABLE 2
Special scene processing rule table

| Scene | Condition | Determination logic | Response action |
|---|---|---|---|
| A | MBD ≤ 0.3 and the | The historical | If IP malicious score > |
| | matching degree is | reputation verification | threshold → level 2 is |
| | 50%-69%. | is started. | upgrade, otherwise level 1 is |
| | | | maintained. |
| B | MBD ≤ 0.3 and the | The depth detection | The level 2 is temporarily |
| | matching degree < | protocol is forcibly | marked during |
| | 50%. | activated. | asynchronous analysis. |
| C | MBD = 0.6-0.9 and | The integrity of | The watermark is tampered |
| | matching degree ≥ | watermark is verify. | → level 3 is upgraded, |
| | 90% | | otherwise level 2 is |
| | | | maintained. |
| D | MBD > 0.9 and | The new threat | The level 3 is upgrade |
| | matching degree ≥ | variants (needing | immediately, and |
| | 90% | expert review) are | confrontation sample is |
| | | marked. | generated. |

Further, the attack chain rule matching performs correlation analysis between the behavior trajectory graph and the attack chain fragment library, anomaly behavior types (such as network scanning, vulnerability exploitation and lateral movement) are marked, and the unique identifier of the matched attack chain fragment and the mapping behavior deviation degree are extracted.

Further, based on the five-tuple information of the structured log data set, the affected infrastructure resources are located in combination with the asset management system database, and the anomaly behavior time window, including the start timestamp, the end timestamp and the duration, is recorded by the time sequence analysis module.

Further, a three-dimensional situation graph is constructed and outputted, where the three-dimensional situation graph includes an asset graph, a behavior graph and a threat graph; and a report field is integrated, where the report field includes a determination result of the risk level, the anomaly behavior type, the identifier of the attack chain fragments, the mapping behavior deviation degree, the affected infrastructure resources and the time windows, and the network mapping behavior anomaly detection report is obtained.

Specifically, in the construction stage of three-dimensional situation graph, the asset graph shows the network hierarchical relationship of the attacked assets in the form of topological graph, such as core switch→Web server→database, and the behavior graph presents the distribution of attack behaviors through time series heatmap (X axis is the time window, Y axis is the attack stage, and color depth presents frequency). Threat graph shows the relationship between attack chain fragments and CVE (Common Vulnerabilities and Exposures) and APT organizations based on knowledge map, such as CVE-2023-1234→APT29 (No.29 Advanced Persistent Threat Organization).

Furthermore, the risk level, anomaly type, attack chain identifier, mapping deviation degree value, affected assets list (including asset name, IP address and service type) and time window parameters are encapsulated into a standardized JSON (JavaScript Object Notation, script language object representation method) structure, and visual assemblies are added to generate an interactive three-dimensional situation graph (supporting the rendering of web graphics library) to form a complete network mapping behavior anomaly detection report and output it.

Preferably, the anomaly behavior are classified according to the preset risk level judgment standard by synthesizing the output of the anomaly detection model and the mapping behavior deviation index, and the anomaly type is marked by combining the behavior path verification results, and the attack chain fragment identifier and the affected infrastructure resources are extracted. The range of attack influence is displayed through three-dimensional situation graph (asset graph, behavior graph and threat graph), and the key information is packaged into standardized JSON format for output, which realizes automatic analysis, accurate judgment and efficient response of network mapping behavior, facilitates integrated call and visual presentation, and clarifies the range of attack influence, providing accurate basis for post-event forensics, vulnerability repair and defense reinforcement.

The disclosure also provides a network mapping behavior anomaly detection system based on machine learning, which is used for realizing the network mapping behavior anomaly detection method based on machine learning. The system includes a control module, where the control module includes a memory, a processor and a computer program stored in the memory and capable of running on the processor, and the processor executes the computer program to realize the network mapping behavior anomaly detection method based on machine learning.

The embodiment of the disclosure provides a storage medium on which a program is stored, and when the program is executed by a processor, the network mapping behavior anomaly detection method based on machine learning is realized.

The embodiment of the disclosure provides a processor, which is used for running a program, where, when the program runs, the network mapping behavior anomaly detection method based on machine learning is executed.

The embodiment of the disclosure provides a device, which includes a processor, a memory and a program stored in the memory and capable of running on the processor, where when the processor executes the program, a network mapping behavior anomaly detection method based on machine learning is realized. The devices in the disclosure may be servers, PCs, PADs, mobile phones, etc.

The disclosure further provides a computer program product, which, when executed on a data processing device, is suitable for executing a network mapping behavior anomaly detection method based on machine learning.

It should be understood by those skilled in the art the embodiments of the disclosure may provide methods, systems, or computer program products. Therefore, the disclosure may take the form of an entirely hardware embodiment, an entirely software embodiment, or an embodiment combining software and hardware aspects. Moreover, the disclosure may take the form of a computer program product implemented on one or more computer-usable storage media (including but not limited to disk storage, CD-ROM, optical storage, etc.) containing computer-usable program codes.

The disclosure is described with reference to flowcharts and/or block diagrams of methods, devices (systems), and computer program products according to embodiments of the disclosure. It should be understood that each flow and/or block in the flowchart and/or block diagram, and combinations of the flow and/or block in the flowchart and/or block diagram may be implemented by computer program instructions. These computer program instructions may be provided to a processor of a general-purpose computer, special-purpose computer, embedded processor or other programmable data processing device to produce a machine, such that the instructions which are executed by the processor of the computer or other programmable data processing device produce means for implementing the functions specified in the one or more flows in the flow charts and/or one or more blocks in the block diagrams.

These computer program instructions may also be stored in a computer-readable memory that may direct a computer or other programmable data processing device to function in a particular manner, such that the instructions stored in the computer-readable memory produce manufacture including instruction means, the instruction means implements the functions specified in one or more flows in the flow charts and/or one or more blocks in the block diagrams.

These computer program instructions may also be loaded onto a computer or other programmable data processing devices, such that a series of operational steps are performed on the computer or other programmable devices to produce a computer-implemented process, such that the instructions executed on the computer or other programmable device provide steps for implementing the functions specified in the flowchart flow or flows and/or block or blocks of the block diagram.

In a typical configuration, a computing device includes one or more processors (CPU), input/output interfaces, network interfaces, and memory.

Memory may include non-permanent memory, random access memory (RAM) and/or nonvolatile memory in computer-readable media, such as read-only memory (ROM) or flash memory. Memory is an example of a computer-readable medium.

Computer-readable media, including permanent and non-permanent, removable and non-removable media, may store information by any method or technology. Information may be computer-readable instructions, data structures, modules of programs or other data. Examples of storage media for computers include, but not limited to phase-change random access memory (PRAM), static random access memory (SRAM), dynamic random access memory (DRAM), other types of random access memory (RAM), read-only memory (ROM), electrically erasable programmable read-only memory (EEPROM), flash memory or other memory technologies, compact disc read-only memory (CD-ROM), and digital versatile disc (DVD), or other optical storage, magnetic cassettes, magnetic tape disk storage or other magnetic storage devices or any other non-transmission medium, may be used to store information that may be accessed by computing devices. According to the definition in the disclosure, computer-readable media may not include temporary computer-readable media (transitory media), such as modulated data signals and carrier waves.

It should also be noted that the terms “including”, “include” or any other variation thereof are intended to cover non-exclusive inclusion, so that a process, method, commodity or device including a series of elements includes not only those elements, but also other elements not explicitly listed, or elements inherent to such process, method, commodity or device. Without more restrictions, the element defined by the sentence “including one” may not exclude that there are other identical elements in the process, method, commodity or device including the element.

The above are only embodiments of the disclosure, and are not used to limit the disclosure. For those skilled in that art, various modifications and variations are possible in the disclosure. Any modification, equivalent substitution, improvement, etc. made within the spirit and principle of the disclosure should be included in the scope of the claims of the disclosure.

What is claimed is:

1. A network mapping behavior anomaly detection method based on machine learning, comprising:
collecting dual-source traffic data based on honeypot nodes, generating a structured log data set through dual-source log fusion engine;
constructing an anomaly detection model and attack chain fragments based on the structured log data set, and generating attack behavior deduction rules according to the attack chain fragments;
performing subgraph matching calculation based on the structured log data set and the attack behavior deduction rules to obtain a mapping behavior deviation degree;
generating communication data containing a watermark identifier in a session corresponding communication path based on the mapping behavior deviation degree;
verifying whether attack events carry the watermark identifier, and updating the anomaly detection model according to verification results; and
generating a network mapping behavior anomaly detection report according to output of an updated anomaly detection model and the mapping behavior deviation degree.

2. The network mapping behavior anomaly detection method based on machine learning according to claim 1, wherein constructing an anomaly detection model and attack chain fragments based on the structured log data set, and generating attack behavior deduction rules according to the attack chain fragments comprise:
extracting attack context labels from the structured log data set;
combining protocol interaction temporal features and service access distribution features according to the attack context labels, so as to construct a model analysis feature vector;
based on the model analysis feature vector, learning a sequence transfer pattern of the attack context labels by using long short-term memory networks, and identifying statistical outliers of protocol interaction parameters by using an isolated forest algorithm to construct the anomaly detection model;
extracting frequent itemsets from an attack context sequence in the structured log data set by using a frequent pattern growth algorithm, and generating the attack chain fragments according to the frequent itemsets; and
converting the attack chain fragments into the executable behavior deduction rules by using a protocol feature mapping method.

3. The network mapping behavior anomaly detection method based on machine learning according to claim 1, wherein performing subgraph matching calculation based on the structured log data set and the attack behavior deduction rules to obtain a mapping behavior deviation degree comprises:
converting the attack chain fragments in the attack behavior deduction rules into an attack chain graph;
extracting protocol interaction event streams of a current session from the structured log data set, constructing a behavior trajectory graph, and marking temporal relationships between events;
searching a subgraph matched with the attack chain graph in the behavior trajectory graph by adopting a graph structure matching algorithm, and calculating structural similarity between a matched subgraph and the attack chain graph; and
performing time constraint verification on the matched subgraph, and calculating the mapping behavior deviation degree based on the structural similarity and time constraint verification results.

4. The network mapping behavior anomaly detection method based on machine learning according to claim 1, wherein generating communication data containing a watermark identifier in a session corresponding communication path based on the mapping behavior deviation degree comprises:
when the mapping behavior deviation degree exceeds a set deviation degree threshold, determining whether there is a potential attack risk in a session;
when there is the potential attack risk in the session, selecting a corresponding watermark injection strategy according to a current communication protocol to generate the communication data containing the watermark identifier; and
performing a protocol specification compliance check on the communication data containing the watermark identifier.

5. The network mapping behavior anomaly detection method based on machine learning according to claim 1, wherein verifying whether attack events carry the watermark identifier comprises:
continuously monitoring whether the watermark identifier is carried in an attack event subsequent request, and recording a carry state of the watermark identifier; and
performing behavior path verification by comparing a behavior trajectory of the watermark identifier carried by the attack events with an expected path in the attack behavior deduction rules.

6. The network mapping behavior anomaly detection method based on machine learning according to claim 5, wherein updating the anomaly detection model according to verification results comprises:
if an attack event behavior trajectory matches attack chain rules and completely carries the watermark identifier, marking a data record of an attack as an attack chain matching normal sample; and
if the attack event behavior trajectory deviates from a path, or the watermark identifier is tampered with or deleted, marking a data record of an attack as an attack chain matching anomaly sample, and triggering the anomaly detection model to adjust.

7. The network mapping behavior anomaly detection method based on machine learning according to claim 6, wherein updating the anomaly detection model according to verification results further comprises:
for the attack chain matching normal sample, increasing a confidence score of a corresponding rule in the attack chain rules; and
for the attack chain matching anomaly sample, based on a tampered pattern of the watermark identifier, constructing an adversarial sample, adding the adversarial sample to a training set of the anomaly detection model, and adjusting parameter weights of the anomaly detection model.

8. The network mapping behavior anomaly detection method based on machine learning according to claim 5, wherein generating a network mapping behavior anomaly detection report according to output of an updated anomaly detection model and the mapping behavior deviation degree comprises:
combining the output of the updated anomaly detection model and the mapping behavior deviation degree, and determining a risk level of the network mapping behavior abnormality according to results of the behavior path verification;
marking an anomaly behavior type, and extracting an identifier of the attack chain segment and the mapping behavior deviation degree matching with a current behavior;
marking affected infrastructure resources based on the structured log data set; and
recording time windows when anomaly behaviors occur.

9. The network mapping behavior anomaly detection method based on machine learning according to claim 8, wherein generating a network mapping behavior anomaly detection report according to output of an updated anomaly detection model and the mapping behavior deviation degree further comprises:
constructing and outputting a three-dimensional situation graph, wherein the three-dimensional situation graph comprises an asset graph, a behavior graph and a threat graph; and
integrating a report field, wherein the report field comprises a determination result of the risk level, the anomaly behavior type, the identifier of the attack chain fragments, the mapping behavior deviation degree, the affected infrastructure resources and the time windows, and obtaining the network mapping behavior anomaly detection report.

10. A network mapping behavior anomaly detection system based on machine learning, comprising a control module, wherein the control module comprises a memory, a processor and a computer program stored in the memory and executable on the processor, and the processor executes the computer program to realize the network mapping behavior anomaly detection method based on machine learning according to claim 1.
